(19) United States
(12) Patent Application Publication
(10) Pub. No.: US 2022/0083596 A1
(43) Pub. Date: Mar. 17, 2022

(54) INFORMATION PROCESSING APPARATUS AND INFORMATION PROCESSING METHOD

(71) Applicant: Sony Group Corporation, Tokyo (JP)

(72) Inventor: Keiichi YAMADA, Tokyo (JP)

(73) Assignee: Sony Group Corporation, Tokyo (JP)

(21) Appl. No.: 17/413,957

(22) PCT Filed: Nov. 15, 2019
(86) PCT No.: PCT/JP2019/044894

§ 371 Date: Jun. 15, 2021

(30) Foreign Application Priority Data
Jan. 17, 2019 (JP) 2019-005780

(51) Int. Cl. G06F 16/903; H04N 5/232; G10L 25/54

(52) U.S. Cl. CPC G06F 16/903; G10L 25/54; H04N 5/23203

(57) ABSTRACT

An information processing apparatus that includes a control unit that controls registration of an item targeted for a location search is provided and the control unit issues an image capturing command to an input device and causes registration information that includes at least image information on the item captured by the input device and label information related to the item to be dynamically generated. Furthermore, an information processing apparatus that includes a control unit that controls a location search for an item based on registration information is provided and the control unit searches for label information on the item included in the registration information by using a search key extracted from a semantic analysis result of collected speeches of a user and, when a relevant item is present, the control unit causes response information related to the location of the item to be output based on the registration information.

### FIELD

The present disclosure relates to an information processing apparatus and an information processing method.

### BACKGROUND

In recent years, a system that manages locations of various kinds of items, such as belongings. For example, Patent Literature 1 discloses a technology for exhibiting, to a user when a position of a storage body in which an item is stored is changed, position information on a storage location of the item that is located after the position change.

### CITATION LIST

### Patent Literature

Patent Literature 1: JP2018-158770 A

### SUMMARY

### Technical Problem

However, as the technology described in Patent Literature 1, if a bar code is used for position management of the above described storage body, a burden imposed on a user at the time of registration is increased. Furthermore, in a case in which a storage body is not present, it is difficult to perform tagging, such as bar codes.

### Solution to Problem

According to the present disclosure, an information processing apparatus is provided that includes: a control unit that controls registration of an item targeted for a location search, wherein the control unit issues an image capturing command to an input device and causes registration information that includes at least image information on an image on the item captured by the input device and label information related to the item to be dynamically generated.

Moreover, according to the present disclosure, an information processing apparatus is provided that includes: a control unit that controls a location search for an item based on registration information, wherein the control unit searches for label information on the item that is included in the registration information by using a search key extracted from a semantic analysis result of collected speeches of a user and, when a relevant item is present, the control unit causes response information related to the location of the item to be output based on the registration information.

Moreover, according to the present disclosure, an information processing method is provided that causes a processor to execute a process including: controlling registration of an item targeted for a location search, wherein the controlling includes issuing an image capturing command to an input device, and generating, dynamically, registration information that includes at least image information on the item captured by the input device and label information related to the item.

Moreover, according to the present disclosure, an information processing method is provided that causes a processor to execute a process including: controlling a location search for an item based on registration information, wherein the controlling includes searching label information on the item included in the registration information by using a search key that is extracted from a semantic analysis result of collected speech of a user, and outputting, when an relevant item is present, response information related to a location of the item based on the registration information.

### BRIEF DESCRIPTION OF DRAWINGS

FIG. 1 is a diagram illustrating an outline of an embodiment of the present disclosure.

FIG. 2 is a block diagram illustrating an example of a functional configuration of a wearable terminal according to the embodiment.

FIG. 3 is a block diagram illustrating an example of a functional configuration of an information processing apparatus according to the embodiment.

FIG. 4 is a sequence diagram illustrating the flow of item registration according to the embodiment.

FIG. 5 is a diagram illustrating an example of a speech of a user at the time of item registration and a semantic analysis result according to the embodiment.

FIG. 6 is a diagram illustrating an example of registration information according to the embodiment.

FIG. 7 is a flowchart illustrating the flow of a basic operation of an information processing apparatus 20 at the time of an item search according to the embodiment.

FIG. 8 is a diagram illustrating an example of a speech of the user at the time of an item search and a semantic analysis result according to the embodiment.

FIG. 9 is a flowchart in a case in which the information processing apparatus according to the embodiment performs a search in a dialogue mode.

FIG. 10 is a diagram illustrating an example of narrowing down targets based on a dialogue according to the embodiment.

FIG. 11 is a diagram illustrating an example of extracting another search key based on a dialogue according to the embodiment.

FIG. 12 is a diagram illustrating a real-time search for an item according to the embodiment.

FIG. 13 is a flowchart illustrating the flow of registration of an object recognition target item according to the embodiment.

FIG. 14 is a sequence diagram illustrating the flow of an automatic addition of image information based on an object recognition result according to the embodiment.

FIG. 15 is a diagram illustrating an example of a hardware configuration of an information processing apparatus according to an embodiment of the present disclosure.

### DESCRIPTION OF EMBODIMENTS

Preferred embodiments of the present disclosure will be explained in detail below with reference to accompanying drawings. Furthermore, in this specification and the drawings, by assigning the same reference numerals to components substantially having the same functional configuration, overlapping descriptions thereof will be omitted.

Furthermore, descriptions will be given in the following order.
1. Embodiment
1.1. Outline
1.2. Example of system configuration
1.3. Example of functional configuration of wearable terminal 10
1.4. Example of functional configuration of information processing apparatus 20
1.5. Operation
2. Example of hardware configuration
3. Conclusion

### 1. Embodiment

### 1.1. Outline

First, an outline of an embodiment of the present disclosure will be described. For example, in home, an office, or the like, when various items, such as articles for daily use, miscellaneous goods, clothes, or books, are needed, if the locations of the items are not found, it sometimes takes efforts and time to search for the items or it is not able to find the items. Furthermore, in order to avoid the situation described above, it is difficult to remember the locations of all of the items, such as belongings, and, if a search target is an item owned by another person (for example, family, colleagues, etc.), the degree of difficulty is further increased.

Accordingly, in recent years, applications and services for managing items, such as belongings, are developed; however, in some cases, it is not possible to register the locations of the items even though registration of the items themselves is possible, or information about the locations is registered only by text information, and thus, it is hard to say that alleviation effects of efforts and time needed to search for necessary items is sufficient.

Furthermore, for example, as described in Patent Literature 1, there is the technology for managing information on items and storage locations by using various kinds of tags, such as bar codes or RFID; however, in this case, dedicated tags are needed to be prepared by a required number of tags, thus resulting in an increase in a burden imposed on a user.

The technical idea according to the present disclosure has been conceived by focusing on the point described above and implements a location search for an item that further reduces a burden imposed on a user. For this purpose, as one of the features, an information processing apparatus 20 according to an embodiment of the present disclosure includes a control unit 240 that controls registration of an item that is a target for a location search, and the control unit 240 issues an image capturing command to an input device and dynamically generates registration information that includes at least image information on an item captured by the input device and label information related to the item.

Furthermore, the control unit 240 in the information processing apparatus 20 according to an embodiment of the present disclosure further controls a location search for the item based on the registration information. At this time, as one of the features, the control unit 240 searches for the label information on the item that is included in the registration information by using a search key extracted from a semantic analysis result of collected speeches of a user and, if the target item is present, the control unit 240 causes response information related to the location of the item to be output based on the registration information.

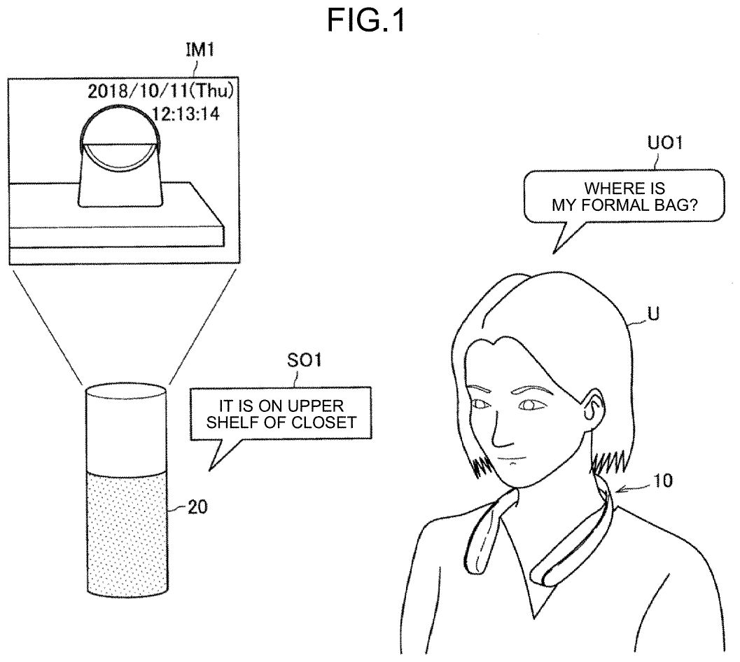

FIG. 1 is a diagram illustrating an outline of an embodiment according to the present disclosure. FIG. 1 illustrates a user U who gives a speech UO1 of asking a location of the user's own formal bag and the information processing apparatus 20 that searches for the registration information that is previously registered based on the speech UO1 and that outputs response information indicating the location of the formal bag.

The information processing apparatus 20 according to the embodiment is one of various kinds of devices each including an intelligent agent function. In particular, the information processing apparatus 20 according to the embodiment has a function for controlling an output of the response information related to the location search for the item while conducting a dialogue with the user U by using a voice.

The response information according to the embodiment includes, for example, image information IM1 on a captured image of the location of the item. If the image information IM1 is included in the acquired registration information as a result of the search, the control unit 240 in the information processing apparatus 20 performs control such that the image information IM1 is displayed by a display, a projector, or the like.

Here, the image information IM1 may also be information indicating the location of the item captured by the input device at the time of registration (or, at the time of an update) of the item. When the user U stores, for example, an item, the user U is able to capture the item by a wearable terminal 10 or the like and register the item as the target for a location search by giving an instruction by a speech. The wearable terminal 10 is an example of the input device according to the embodiment.

Furthermore, the response information according to the embodiment may also include voice information that indicates the location of the item. The control unit 240 according to the embodiment performs control, based on space information included in the registration information, such that voice information on, for example, a system speech SO1 is output. The space information according to the embodiment indicates the position of the item in a predetermined space (for example, a home of the user U) or the like and may also be generated based on the speech of the user at the time of registration (or, at the time of an update) or the position information from the wearable terminal 10.

In this way, with the control unit 240 according to the embodiment, it is possible to easily implement registration of or a location search for an item by using a voice dialogue and it is thus possible to greatly reduce the burden imposed on the user at the time of the registration and the search. Furthermore, the control unit 240 causes the response information that includes the image information IM1 to be output, so that it is possible for the user to intuitively grasp the location of the item and it is thus possible to effectively reduce efforts and time needed to search for the item.

In the above, the outline of an embodiment of the present disclosure has been described. In the following, a configuration of an information processing system that implements the above described function and the function effected by the configuration will be described in detail.

### 1.2. Example of System Configuration

First, an example of a configuration of an information processing system according to the embodiment will be described. The information processing system according to the embodiment includes, for example, the wearable terminal 10 and the information processing apparatus 20. Furthermore, the wearable terminal 10 and the information processing apparatus 20 are connected so as to be capable of performing communication with each other via a network 30.

(Wearable Terminal 10)

The wearable terminal 10 according to the embodiment is an example of the input device. The wearable terminal 10 may also be, for example, a neckband-type terminal as illustrated in FIG. 1, or an eyeglass-type or a wristband-type terminal. The wearable terminal 10 according to the embodiment includes a voice collection function, an image capturing function, and a voice output function and may be various kinds of terminals that is wearable for the user.

In contrast, the input device according to the embodiment is not limited to the wearable terminal 10 and may also be, for example, a microphone, a camera, a loudspeaker, or the like that is fixedly installed in a predetermined space in a user's home, an office, or the like.

(Information Processing Apparatus 20)

The information processing apparatus 20 according to the embodiment is a device that performs registration control and search control of items. The information processing apparatus 20 according to the embodiment may also be, for example, a dedicated device that has an intelligent agent function. Furthermore, the information processing apparatus 20 may also be a personal computer (PC), a tablet, a smartphone, or the like that has the above described function.

(Network 30)

The network 30 has a function for connecting the input device and the information processing apparatus 20. The network 30 according to the embodiment includes a wireless communication network, such as Wi-Fi (registered trademark) and Bluetooth (registered trademark). Furthermore, if the input device is a device that is fixedly installed in a predetermined space, the network 30 includes various kinds of wired communication networks.

In the above, the example of the configuration of the information processing system according to the embodiment has been described. Furthermore, the configuration described above is only an example and the configuration of the information processing system according to the embodiment is not limited to the example. The configuration of the information processing system according to the embodiment may be flexibly modified in accordance with specifications or operations.

### 1.3. Example of Functional Configuration of Wearable Terminal 10

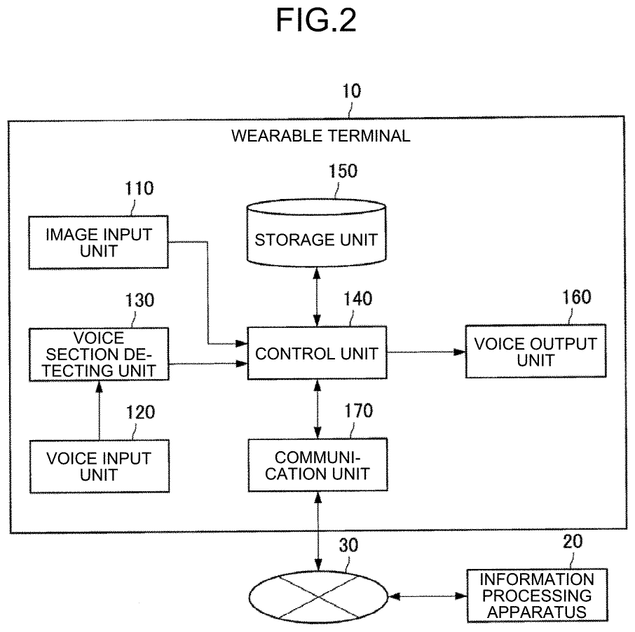

In the following, an example of a functional configuration of the wearable terminal 10 according to the embodiment will be described. FIG. 2 is a block diagram illustrating an example of the functional configuration of the wearable terminal 10 according to the embodiment. With reference to FIG. 2, the wearable terminal 10 according to the embodiment includes an image input unit 110, a voice input unit 120, a voice section detecting unit 130, a control unit 140, a storage unit 150, a voice output unit 160, and a communication unit 170.

(Image Input Unit 110)

The image input unit 110 according to the embodiment captures an image of an item based on an image capturing command received from the information processing apparatus 20. For this purpose, the image input unit 110 according to the embodiment includes an image sensor or a web camera.

(Voice Input Unit 120)

The voice input unit 120 according to the embodiment collects various sound signals including a speech of the user. The voice input unit 120 according to the embodiment includes, for example, a microphone array with two channels or more.

(Voice Section Detecting Unit 130)

The voice section detecting unit 130 according to the embodiment detects, from the sound signal collected by the voice input unit 120, a section in which a voice of a speech given by the user is present. The voice section detecting unit 130 may also estimate start time and end time of, for example, a voice section.

(Control Unit 140)

The control unit 140 according to the embodiment controls an operation of each of the configurations included in the wearable terminal 10.

(Storage Unit 150)

The storage unit 150 according to the embodiment stores therein a control program or application for operating each of the configurations included in the wearable terminal 10.

(Voice Output Unit 160)

The voice output unit 160 according to the embodiment outputs various sounds. The voice output unit 160 outputs recorded voices or synthesized voices as response information based on control performed by, for example, the control unit 140 or the information processing apparatus 20.

(Communication Unit 170)

The communication unit 170 according to the embodiment performs information communication with the information processing apparatus 20 via the network 30. For example, the communication unit 170 transmits the image information acquired by the image input unit 110 or the voice information acquired by the voice input unit 120 to the information processing apparatus 20. Furthermore, the communication unit 170 receives, from the information processing apparatus 20, various kinds of control information related to an image capturing command or the response information.

In the above, the example of the functional configuration of the wearable terminal 10 according to the embodiment has been described. Furthermore, the functional configuration described above with reference to FIG. 2 is only an example and an example of the functional configuration of the wearable terminal 10 according to the embodiment is not limited to the example. The functional configuration of the wearable terminal 10 according to the embodiment may be flexibly modified in accordance with specifications or operations.

### 1.4. Example of a Functional Configuration of the Information Processing Apparatus 20

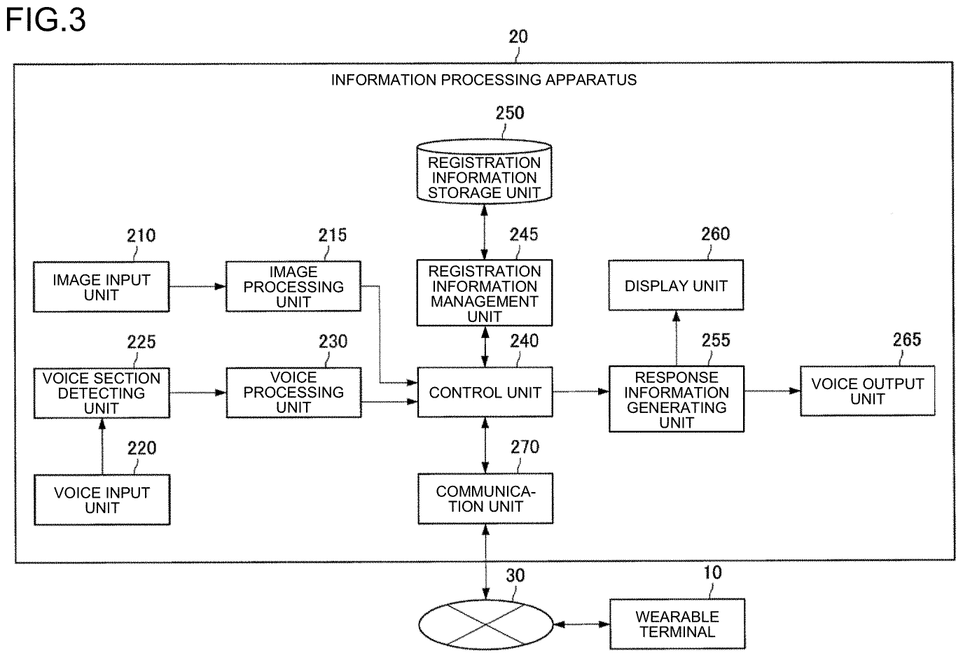

In the following, an example of a functional configuration of the information processing apparatus 20 according to the embodiment will be described. FIG. 3 is a block diagram illustrating an example of the functional configuration of the information processing apparatus 20 according to the embodiment. As illustrated in FIG. 3, the information processing apparatus 20 according to the embodiment includes an image input unit 210, an image processing unit 215, a voice input unit 220, a voice section detecting unit 225, a voice processing unit 230, the control unit 240, a registration information management unit 245, a registration information storage unit 250, a response information generating unit 255, a display unit 260, a voice output unit 265, and a communication unit 270. Furthermore, the functions held by the image input unit 210, the voice input unit 220, the voice section detecting unit 225, and the voice output unit 265 may be substantially the same as the functions held by the image input unit 110, the voice input unit 120, the voice section detecting unit 130, and the voice output unit 160, respectively, included in the wearable terminal 10; therefore, descriptions thereof in detail will be omitted.

(Image Processing Unit 215)

The image processing unit 215 according to the embodiment performs various processes based on input image information. The image processing unit 215 according to the embodiment detects an area in which, for example, an object or a person is estimated to be present from the image information. Furthermore, the image processing unit 215 performs object recognition based on the detected object area or a user identification based on the detected person area. The image processing unit 215 performs the above described process based on an input of the image information acquired by the image input unit 210 or the wearable terminal 10.

(Voice Processing Unit 230)

The voice processing unit 230 according to the embodiment performs various processes based on voice information that has been input. The voice processing unit 230 according to the embodiment performs a voice recognition process on, for example, the voice information and converts a voice signal to text information that is associated with the content of the speech. Furthermore, the voice processing unit 230 analyzes an intention of a speech of the user from the above described text information by using the technology, such as natural language processing. The voice processing unit 230 performs the above described process based on an input of the voice information acquired by the voice input unit 220 or the wearable terminal 10.

(Control Unit 240)

The control unit 240 according to the embodiment performs registration control or search control of the item based on the results of the processes performed by the image processing unit 215 and the voice processing unit 230. The function held by the control unit 240 according to the embodiment will be described in detail later.

(Registration Information Management Unit 245)

The registration information management unit 245 according to the embodiment performs, based on the control performed by the control unit 240, control of generating or updating the registration information related to the item and a search process on the registration information.

(Registration Information Storage Unit 250)

The registration information storage unit 250 according to the embodiment stores therein the registration information that is generated or updated by the registration information management unit 245.

(Response Information Generating Unit 255)

The response information generating unit 255 according to the embodiment generates, based on the control performed by the control unit 240, the response information to be exhibited to the user. An example of the response information includes a display of visual information using GUI or an output of a recorded voice or a synthesized voice. For this purpose, the response information generating unit 255 according to the embodiment has a voice synthesizing function.

(Display Unit 260)

The display unit 260 according to the embodiment displays visual response information generated by the response information generating unit 255. For this purpose, the display unit 260 according to the embodiment includes various displays or projectors.

In the above, the example of the functional configuration of the information processing apparatus 20 according to the embodiment has been described. Furthermore, the configuration described above with reference to FIG. 3 is only an example and the functional configuration of the information processing apparatus 20 according to the embodiment is not limited to this. For example, the image processing unit 215 or the voice processing unit 230 may also be included in a server that is separately provided. The functional configuration of the information processing apparatus 20 according to the embodiment may be flexibly modified in accordance with specifications or operations.

### 1.5. Operation

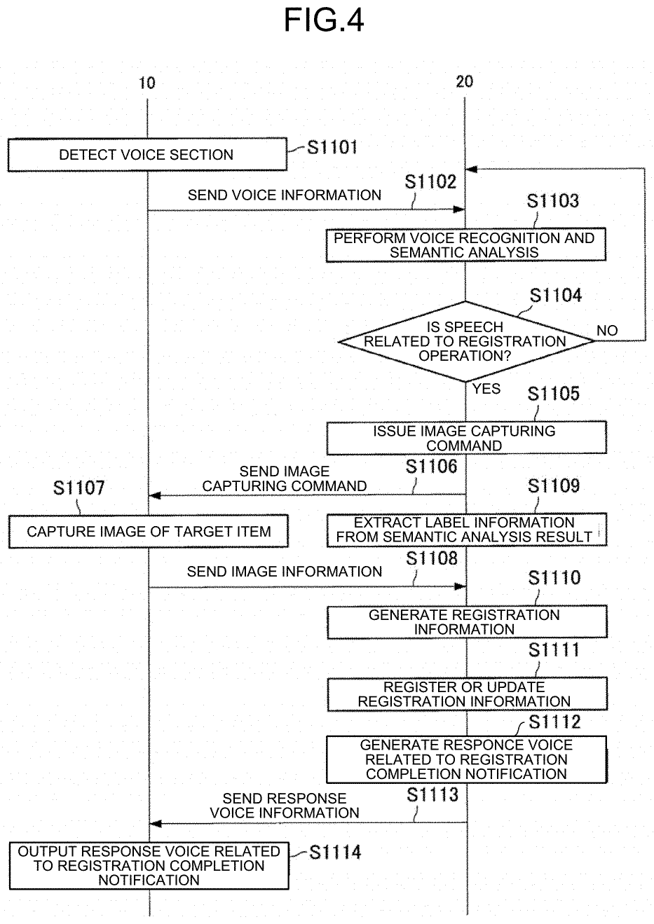

In the following, an operation of the information processing system according to the embodiment will be described in detail. First, the operation at the time of item registration according to the embodiment will be described. FIG. 4 is a sequence diagram illustrating the flow of the item registration according to the embodiment.

As illustrated in FIG. 4, when the user gives a speech, the wearable terminal 10 detects a voice section that is associated with the speech (S1101), and the voice information that is associated with the detected voice section is sent to the information processing apparatus 20 (S1102).

Then, the information processing apparatus 20 performs voice recognition and semantic analysis on the voice information that has been received at Step S1102, and acquires text information and the semantic analysis result that are associated with the speech given by the user (S1103).

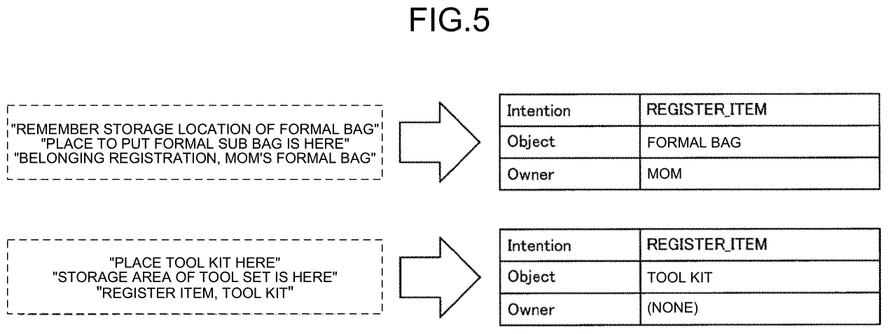

FIG. 5 is a diagram illustrating an example of the speech of the user and the semantic analysis result at the time of the item registration according to the embodiment. The upper portion of FIG. 5 illustrates an example of a case in which the user newly registers the location of a formal bag. At this time, it is assumed that the user uses various expressions as illustrated in the drawing; however, according to the semantic analysis process, a unique result that is associated with an intention of the user is acquired. Furthermore, for example, if a word indicating the owner of the item, such as “mom's formal bag”, is included in the speech of the user, the voice processing unit 230 is able to extract the relevant owner as a part of the semantic analysis result, as illustrated in the drawing.

Furthermore, the lower portion of FIG. 5 illustrates an example of a case in which the user newly registers the location of a tool kit. Similarly to the above described case, the semantic analysis result is uniquely determined without depending on the expression of the user. Furthermore, if a word indicating an owner is not included in the speech of the user, the owner information is not needed to be extracted.

In the following, the flow of a registration operation will be described by referring again to FIG. 4. When the process at Step S1103 has been completed, the control unit 240 in the information processing apparatus 20 judges, based on the result of the process performed at Step S1103, whether the speech of the user is the speech related to a registration operation of the item (S1104).

Here, if the control unit 240 judges that the speech of the user is not the speech related to the registration operation of the item (No at S1104), the information processing apparatus 20 returns to a standby state.

In contrast, if the control unit 240 judges that the speech of the user the speech is related to the registration operation of the item (Yes at S1104), the control unit 240 subsequently issues an image capturing command (S1105), and sends the image capturing command to the wearable terminal 10 (S1106).

The wearable terminal 10 captures an image of the target item based on the image capturing command received at Step S1106 (S1107), and sends the image information to the information processing apparatus 20 (S1108).

Furthermore, in parallel to the above described image capturing process performed by the wearable terminal 10, the control unit 240 extracts the label information on the target item based on the result of the semantic analysis acquired at Step S1103 (S1109).

Furthermore, the control unit 240 causes the registration information management unit 245 to generate the registration information that includes, as a single set, both of the image information received at Step S1108 and the label information extracted at Step S1109 (S1110). In this way, one of the features is that, if the speech of the user collected by the wearable terminal 10 indicates an intention to register the item, the control unit 240 according to the embodiment issues the image capturing command and causes the label information to be generated based on the speech of the user. Furthermore, at this time, the control unit 240 is able to cause the registration information management unit 245 to generate the registration information that further includes various kinds of information that will be described later.

Furthermore, the registration information storage unit 250 registers or updates the registration information that is generated at Step S1110 (S1111).

When the registration or the update of the registration information has been completed, the control unit 240 causes the response information generating unit 255 to generate a response voice related to a registration completion notification that indicates the completion of the registration process on the item to the user (S1112), and sends the generated response voice to the wearable terminal 10 via the communication unit 270 (S1113).

Subsequently, the wearable terminal 10 outputs the response voice received at Step S1113 (S1114), and notifies the user of the completion of the registration process on the target item.

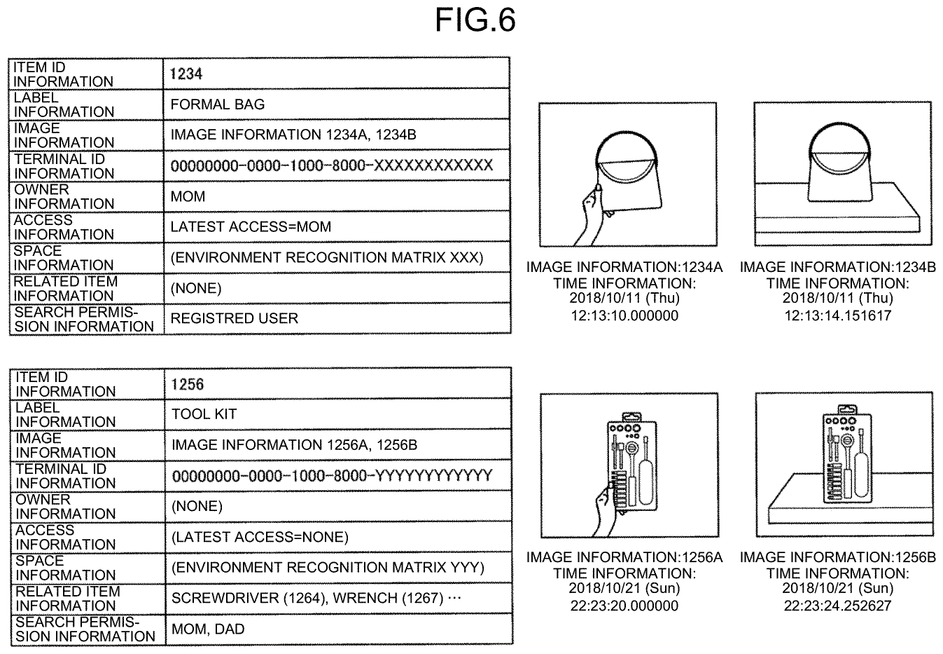

In the above, the flow of the item registration according to the embodiment has been described. In the following, the registration information according to the embodiment will be described in further detail. FIG. 6 is a diagram illustrating an example of the registration information according to the embodiment. Furthermore, the upper portion of FIG. 6 illustrates an example of the registration information related to the item “formal bag” and the lower portion of FIG. 6 illustrates an example of the registration information related to the item “tool kit”.

The registration information according to the embodiment includes item ID information. The item ID information according to the embodiment is automatically allocated by the registration information management unit 245 and is used to manage and search for the registration information.

Furthermore, the registration information according to the embodiment includes label information. The label information according to the embodiment is text information that indicates a name or a nickname of the item. The label information is generated based on the semantic analysis result of the speech of the user at the time of the item registration. Furthermore, the label information may also be generated based on an object recognition result of the image information.

Furthermore, the registration information according to the embodiment includes image information on an item. The image information according to the embodiment is obtained by capturing an image of the item that is a registration target and to which time information indicating the time at which image capturing is performed and an ID is allocated. Furthermore, a plurality of pieces of the image information according to the embodiment may also be included for each item. In this case, the image information with the latest time information is used to output the response information.

Furthermore, the registration information according to the embodiment may also include ID information on the wearable terminal 10.

Furthermore, the registration information according to the embodiment may also include owner information that indicates the owner of the item. The control unit 240 according to the embodiment may cause the registration information management unit 245 to generate owner information based on the result of the semantic analysis of the speech given by the user. The owner information according to the embodiment is used to, for example, narrow down items at the time of a search.

The registration information according to the embodiment may also include access information that indicates history of access to the item by the user. The control unit 240 according to the embodiment causes the registration information management unit 245 to generate or update the access information based on a user recognition result of the image information on the image captured by the wearable terminal 10. The access information according to the embodiment is used when, for example, notifying the last user who accessed the item. The control unit 240 is able to cause the response information including the voice information indicating that, for example, “the last person who used the item is mom” to be output based on the access information. According to this control, even if the item is not present in the location that is indicated by the image information, it is possible for the user to find the item by contacting the last user.

Furthermore, the registration information according to the embodiment may also include space information that indicates the position of the item in a predetermined space. The space information according to the embodiment can be an environment recognition matrix recognized by, for example, a known image recognition technology, such as a structure from motion (SfM) method or a simultaneous localization and mapping (SLAM) method. Furthermore, if the user gives a speech, such as “I place the formal bag on the upper shelf of a closet” at the time of registration of the item, the text information indicating “the upper shelf of the closet” that is extracted from the result of the semantic analysis is generated as the space information.

In this way, the control unit 240 according to the embodiment is able to cause the registration information management unit 245 to generate or update the space information based on the position of the wearable terminal 10 or the speech of the user at the time of capturing the image of the item. Furthermore, the control unit 240 according to the embodiment is able to output, based on the space information, as illustrated in FIG. 1, the response information including the voice information that indicates the location of the item. Furthermore, if the environment recognition matrix is registered as the space information, the control unit 240 may also output, as a part of the response information, the visual information in which the environment recognition matrix is visualized. According to the control described above, it is possible for the user to more accurately grasp the location of the target item.

Furthermore, the registration information according to the embodiment includes the related item information that indicates the positional relationship with another item. An example of the positional relationship described above includes, for example, a hierarchical relationship (inclusion relation). For example, the tool kit illustrated in FIG. 6 as an example includes a plurality of tools, such as a screwdriver and a wrench, as components. In this case, because the item “tool kit” includes the item “screwdriver” and the item “wrench”, the item “tool kit” is at an upper hierarchy level than the hierarchy levels of these two items.

Furthermore, similarly, for example, if the item “formal bag” is stored in an item “suitcase”, the item “suitcase” includes the item “formal bag”; therefore, it can be said that the item “suitcase” is at an upper hierarchy level than the hierarchy level of the item “formal bag”.

If the positional relationship described above is able to be specified from the image information on the item or the speech of the user, the control unit 240 according to the embodiment causes the registration information management unit 245 to generate or update the specified positional relationship as the related item information. Furthermore, the control unit 240 may also cause, based on the related item information, the voice information (for example, “the formal bag is stored in the suitcase”, etc.) indicating the positional relationship with the other item to be output.

According to the control described above, for example, even if the location of the suitcase has been changed, it is possible to correctly track the location of the formal bag included in the suitcase and exhibit the formal bag to the user.

Furthermore, the registration information according to the embodiment may include the search permission information that indicates the user who is permitted to conduct a location search for the item. For example, if a user gives a speech indicating that “I place the tool kit here but please do not tell this to children”, the control unit 240 is able to cause, based on the result of the semantic analysis of the subject speech, the registration information management unit 245 to generate or update the search permission information.

According to the control described above, for example, it is possible to conceal the location of the item that is not desired to be searched by a specific user, such as children, or an unregistered third party, and it is thus possible to improve security and protect privacy.

In the above, the registration information according to the embodiment has been described with specific examples. Furthermore, the content of the registration information explained with reference to FIG. 6 is only an example and the content of the registration information according to the embodiment is not limited to the example. For example, in FIG. 6, a case in which a UUID is only used for the terminal ID information is adopted as an example; however, a UUID may also be similarly used for the item ID information, the image information, or the like.

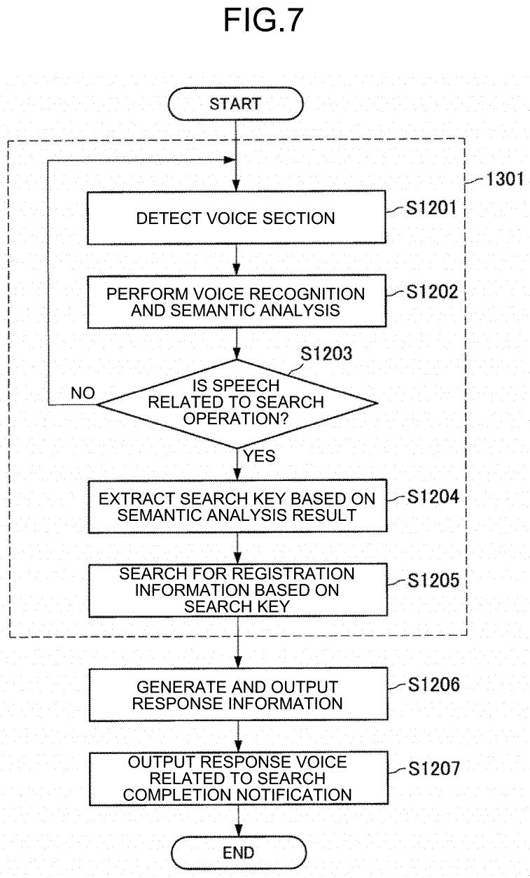

In the following, the flow of the item search according to the embodiment will be described. FIG. 7 is a flowchart illustrating the flow of a basic operation of the information processing apparatus 20 at the time of an item search according to the embodiment.

With reference to FIG. 7, first, the voice section detecting unit 225 detects, from the input voice information, a voice section that is associated with the speech of the user (S1201).

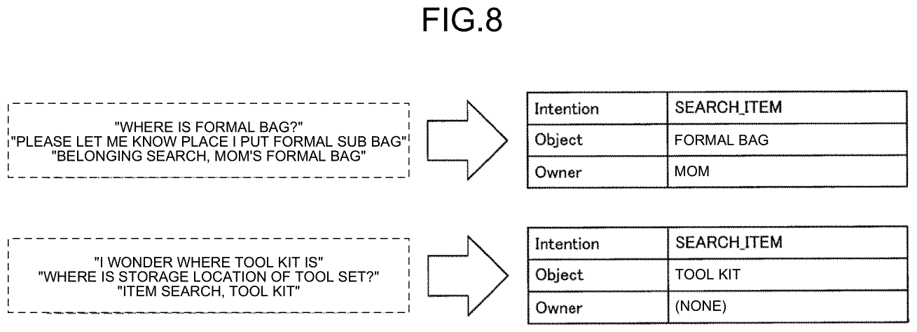

Then, the voice processing unit 230 performs voice recognition and semantic analysis on the voice information that is associated with the voice section detected at Step S1201 (S1202). FIG. 8 is a diagram illustrating an example of the speech of the user and the semantic analysis result at the time of the item search according to the embodiment. The upper portion of FIG. 8 illustrates an example of a case in which the user searches for the location of the formal bag, whereas the lower portion of FIG. 8 illustrates an example of a case in which the user searches for the location of the tool kit.

At this time, also, similarly to a case of item registration, it is conceivable that user uses various expressions; however, according to the semantic analysis process, it is possible to acquire a unique result that is associated with an intention of the user. Furthermore, for example, if a word indicating the owner of the item, such as “mom's formal bag”, is included in the speech of the user, the voice processing unit 230 is able to extract the owner as a part of the semantic analysis result, as illustrated in FIG. 8.

In the following, the flow of an operation at the time of a search will be described by referring again to FIG. 7. Then, the control unit 240 judges, based on the result of the semantic analysis acquired at Step S1202, whether the speech of the user is a speech related to a search operation of the item (S1203).

Here, if the control unit 240 judges that the speech of the user is not the speech related to the search operation of the item (No at S1203), the information processing apparatus 20 returns to a standby state.

In contrast, if the control unit 240 judges that the speech of the user is the speech related to the search operation of the item (Yes at S1203), the control unit 240 subsequently extracts, based on the result of the semantic analysis acquired at Step S1202, a search key that is used to make a match judgement on the label information or the like (S1204). For example, in a case of the example illustrated on the upper portion of FIG. 8, the control unit 240 is able to extract the “formal bag” as the search key associated with the label information and extract the “tool kit” as the search key associated with the owner information.

Then, the control unit 240 causes the registration information management unit 245 to conduct a search using the search key extracted at Step S1204 (S1205).

Then, the control unit 240 controls generation and output of the response information based on the search result acquired at Step S1205 (S1206). As illustrated in FIG. 1, the control unit 240 may also cause the latest image information included in the registration information to be displayed together with the time information, or may also cause the voice information that indicates the location of the item to be output.

Furthermore, the control unit 240 may also cause the response voice related to the search completion notification that indicates the completion of the search to be output (S1207).

In the above, a description has been given of the flow of the basic operation of the information processing apparatus 20 at the time of the item search according to the embodiment. Furthermore, in the above description, a case has been described as one example in which the item that is obtained from a speech of the user at a time as a search result is limited to a single item. However, if the content of the speech of the user is ambiguous, it is conceivable that there may be a situation in which it is not able to specify a target item from the speech of the user at a time.

Accordingly, the information processing apparatus 20 according to the embodiment may also perform a process of narrowing down items targeted by the user in stages by continuing the voice dialogue with the user. More specifically, the control unit 240 according to the embodiment may control an output of the voice information that induces a speech that is given by the user and that is able to be used to acquire a search key that limits the registration information obtained as a search result to a single item.

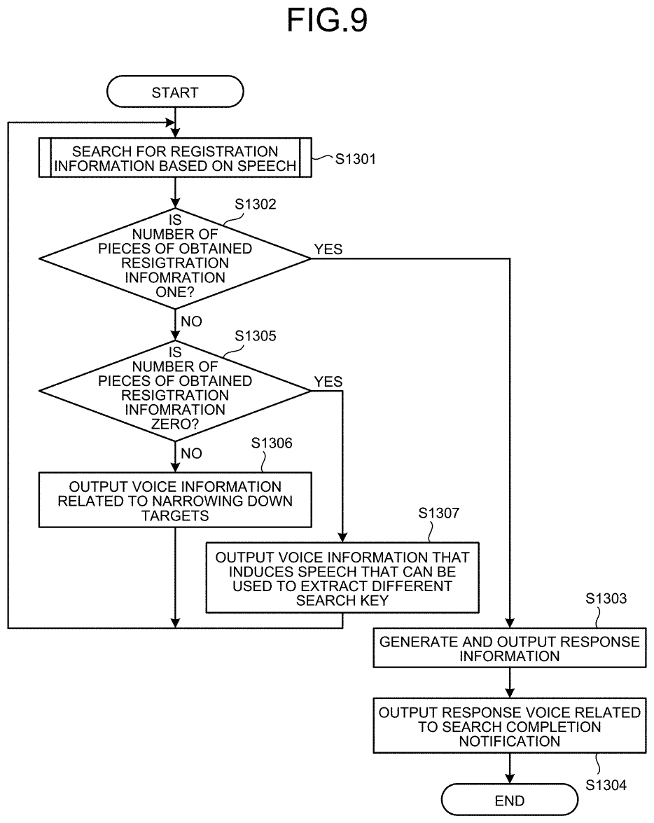

FIG. 9 is a flowchart in a case in which the information processing apparatus 20 according to the embodiment conducts a search in a dialogue mode.

With reference to FIG. 9, the information processing apparatus 20 conducts, first, a registration information search based on the speech of the user (S1301). Furthermore, the process at Step S1301 is able to be substantially the same as the processes at Step S1201 to S1205 illustrated in FIG. 7; therefore, descriptions thereof in detail will be omitted.

Then, the control unit 240 judges whether the number of pieces of the registration information obtained at Step S1301 is one (S1302).

Here, if the number of pieces of the registration information obtained at Step S1301 is one (Yes at S1302), the control unit 240 controls generation and an output of the response information (S1303) and, furthermore, controls an output of the response voice related to the search completion notification (S1304).

In contrast, if the number of pieces of the registration information obtained at Step S1301 is not one (No at S1302), the control unit 240 subsequently judges whether the number of pieces of the registration information obtained at Step S1301 is zero (S1305).

Here, if the number of pieces of the registration information obtained at Step S1301 is not zero (Yes at S1305), i.e., if the number of pieces of the obtained registration information is greater than or equal to two, the control unit 240 causes the voice information related to narrowing down targets to be output (S1306). More specifically, the voice information described above may also induce a speech that is given by the user and that is able to be used to extract a search key that limits the registration information to a single piece of information.

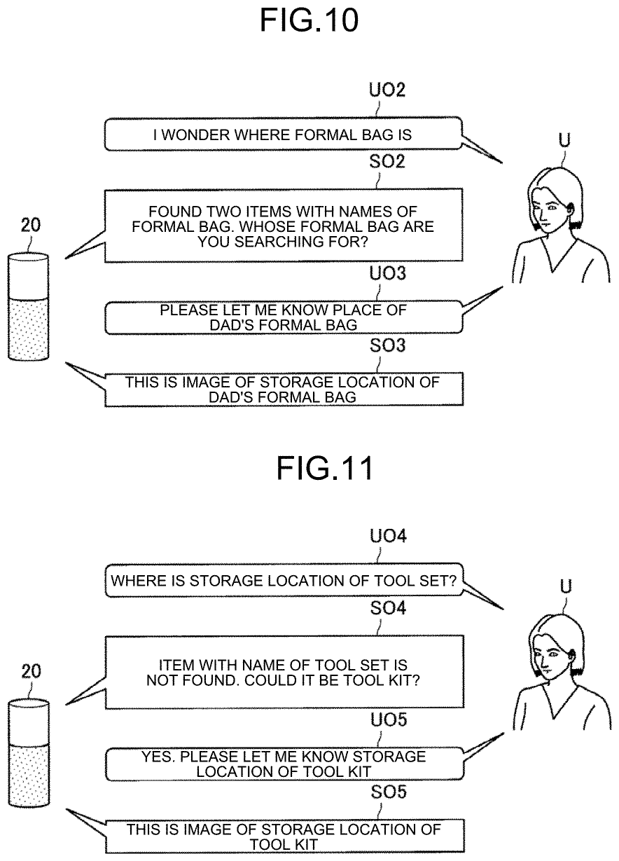

FIG. 10 is a diagram illustrating an example of narrowing down the targets based on the dialogue according to the embodiment. In the example illustrated in FIG. 10, in response to a speech UO2 of the user U who intends to search for the formal bag, the information processing apparatus 20 outputs a system speech SO2 with the content indicating that two pieces of registration information each having a name (search label) of a formal bag have been found and indicating an inquiry about whose belonging the target item is.

In response to this, the user U gives a speech UO3 indicating that the target item is a dad's formal bag. In this case, the control unit 240 causes a search to be again conducted by using the owner information that is obtained as a semantic analysis result of the speech UO3 as a search key, so that the control unit 240 is able to cause a single piece of registration information to be acquired and cause a system speech SO3 to be output based on the registration information.

In this way, if a plurality of pieces of registration information associated with the search key extracted from the speech of the user is present, the control unit 240 is able to narrow down the items targeted by the user by asking the user, for example, additional information, such as an owner.

Furthermore, if the registration information obtained at Step S1301 in FIG. 9 is zero (Yes at S1305), the control unit 240 causes the voice information to be output that induces a speech that is given by the user and that is able to be used to extract a search key that is different from the search key used for the latest search (S1307).

FIG. 11 is a diagram illustrating an example of extracting another search key using a dialogue according to the embodiment. In the example illustrated in FIG. 11, in response to a speech UO4 that is given by the user U and that intends to search for the tool set, the information processing apparatus 20 outputs a system speech SO4 with the content indicating that the registration information having a name (search label) of a tool bag is not found and indicating an inquiry about the possibility that the name of the intended item is a tool kit.

In response to this, the user U gives a speech UO5 with the content recognizing that the name of the item is a tool kit. In this case, the control unit 240 causes a search to be again conducted by using the “tool kit” as a search key based on the semantic analysis result of the speech UO5, so that the control unit 240 is able to cause a single piece of registration information to be acquired and cause a system speech SO5 to be output based on the registration information.

In the above, the flow of the operation and the specific example of a case in which the search according to the embodiment is conducted in a dialogue mode have been described. By performing dialogue control described as needed, the control unit 240 according to the embodiment is able to narrow down the registration information that is obtained as a search result and exhibit the location of the item targeted by the user to the user.

In the following, a real-time search of an item according to the embodiment will be described. In the above description, a case has been described in which the information processing apparatus 20 according to the embodiment searches for the registration information that is previously registered and exhibits the location of the item targeted by the user.

In contrast, the function of the information processing apparatus 20 according to the embodiment is not limited to the function described above. The control unit 240 according to the embodiment is also able to control, based on the result of the object recognition with respect to the image information sent from the wearable terminal 10 at predetermined intervals, the response information that indicates the location of the item searched by the user in real time.

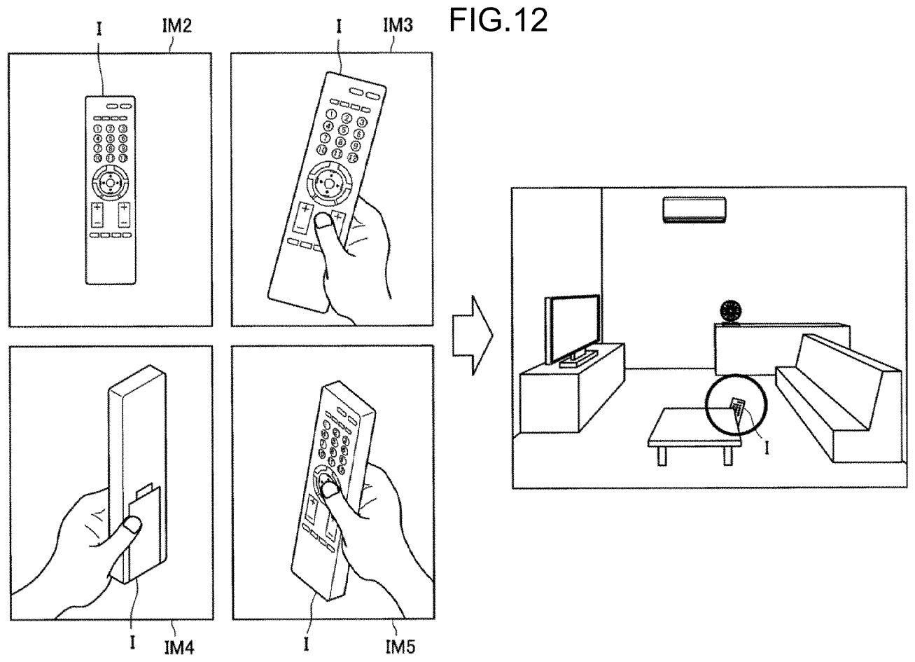

FIG. 12 is a diagram illustrating a real-time search for the item according to the embodiment. On the left side of FIG. 12, pieces of image information IM2 to IM5 that are used to perform learning related to object recognition are illustrated. The image processing unit 215 according to the embodiment is able to perform leaning related to object recognition of a subject item by using image information IM that is included in the registration information.

At this time, for example, by using a plurality of pieces of image information IM, such as the image information IM on an image of an item I captured from various angles as illustrated in the drawing or the image information IM on an image in which a part thereof is unseen due to a grasping position or the angle of view at the time of the image capturing, it is possible to improve the accuracy of the object recognition of the item I.

When learning described above is performed, at the same time as a search conducted by the user, the control unit 240 according to the embodiment may start a real-time search of an item using object recognition triggered by a speech of, for example, “where is a remote controller?” given by the user.

More specifically, the control unit 240 may cause object recognition of the image information that is acquired by the wearable terminal 10 at predetermined intervals by using time-lapse photography or video shooting to be performed in real time and may cause, if a target item has been recognized, response information that indicates the location of the target item to be output. At this time, the control unit 240 according to the embodiment may also cause voice information indicating, for example, “the searched remote controller is on the right front side of the floor” to be output to the wearable terminal 10 or may also cause the display unit 260 to output the image information indicating that the item I has been recognized and the recognized position.

In this way, with the information processing apparatus according to the embodiment, by searching for the item with the user in real time, it is possible to avoid an oversight by the user or assist or give some advice on the search performed by the user. Furthermore, by using the function of general object recognition, the information processing apparatus 20 is able to search for, in real time, not only the registered items but also an item for which registration information is not registered.

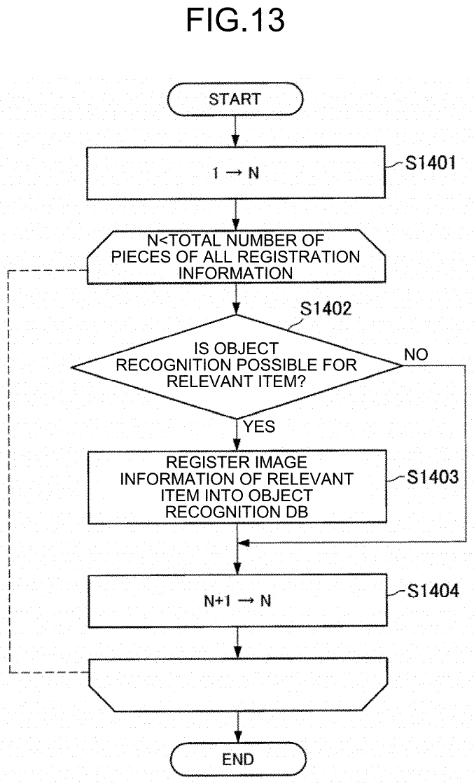

The registration of the object recognition target item according to the embodiment is performed in the flow illustrated in, for example, FIG. 13. FIG. 13 is a flowchart illustrating the flow of the registration of the object recognition target item according to the embodiment.

With reference to FIG. 13, first, the control unit 140 substitute 1 for a variable N (S1401).

Then, the control unit 240 judges whether object recognition is able to be performed on the registration information on the item (S1402).

Here, if object recognition is able to be performed on the item (Yes at S1402), the control unit 240 registers the image information on the subject item into an object recognition DB (S1403).

In contrast, if object recognition is not able to be performed on the item (No at S1402), the control unit 240 skips the process at Step S1403.

Then, the control unit 240 substitutes N+1 for the variable N (S1404).

The control unit 240 repeatedly performs the processes at Steps S1402 to S1404 in a period of time in which N is less than the total number of pieces of all registration information. Furthermore, the registration process described above may also be automatically performed in the background.

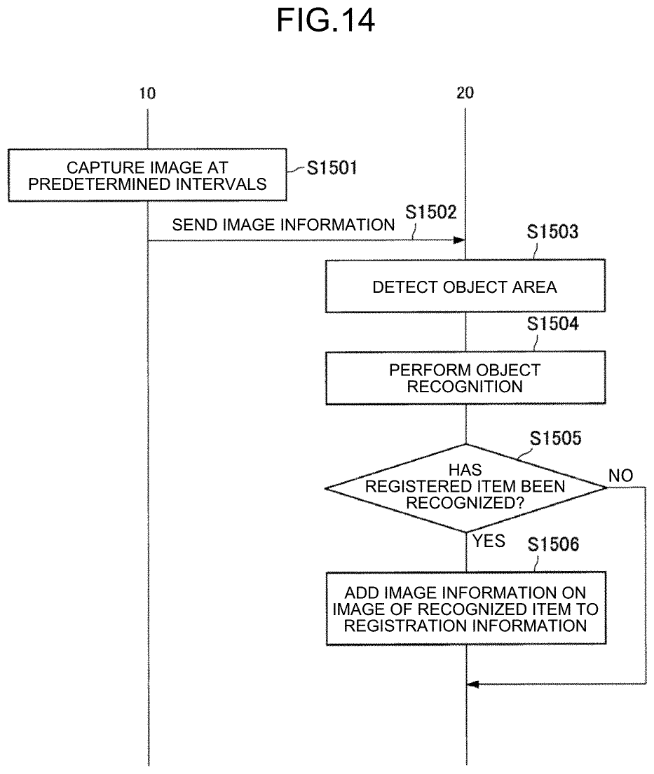

Furthermore, FIG. 14 is a sequence diagram illustrating the flow of automatic addition of the image information based on an object recognition result. For example, if the user always wears the wearable terminal 10 in a user's home, the information processing apparatus 20 may perform, in real time, the object recognition on the image information on the image captured by the wearable terminal 10 at predetermined intervals. Here, if a registered item is recognized, by adding the subject image information to the registration information, it is possible to efficiently increase the number of images to be used to perform learning of object recognition and improve the accuracy of the object recognition.

With reference to FIG. 14, images are captured by the wearable terminal 10 at predetermined intervals (S1501). Furthermore, the wearable terminal 10 sequentially sends the acquired image information to the information processing apparatus 20 (S1502).

Then, the image processing unit 215 in the information processing apparatus 20 detects an object area from the image information that is received at Step S1502 (S1503), and again performs object recognition (S1504).

Then, the control unit 240 judges, at Step S1504, whether a registered item has been recognized (S1505).

Here, if it is judged that the registered item has been recognized (Yes at S1505), the control unit 240 adds the image information on the recognized item to the registration information (S1506).

Furthermore, the control unit 240 is able to add and register not only the result of the object recognition but also the image information based on the semantic analysis result of the speech of the user. For example, if the user who searches for a remote controller gives a speech of “I found it”, it is expected that an image of the remote controller captured at that time is highly likely to be included in the image information.

In this way, if a registered item is recognized from the image information on the image captured by the wearable terminal 10 at predetermined intervals or if it is recognized that a registered item is included in the image information based on the speech of the user, the control unit according to the embodiment may add the subject image information to the registration information on the subject item. According to the control, it is possible to efficiently collect images that can be used to perform learning of object recognition and, furthermore, it is possible to improve the accuracy of the object recognition.

### 2. Example of Hardware Configuration

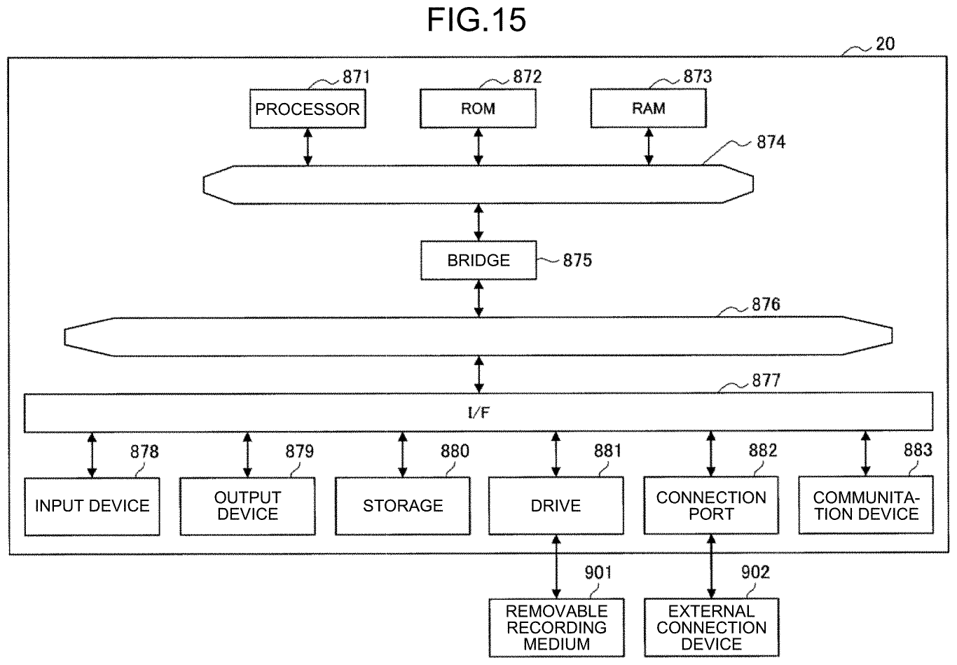

In the following, an example of hardware configuration of the information processing apparatus 20 according to an embodiment of the present disclosure will be described. FIG. 15 is a block diagram illustrating the example of the hardware configuration of the information processing apparatus 20 according to an embodiment of the present disclosure. As illustrated in FIG. 15, the information processing apparatus 20 includes, for example, a processor 871, a ROM 872, a RAM 873, a host bus 874, a bridge 875, an external bus 876, an interface 877, an input device 878, an output device 879, a storage 880, a drive 881, a connection port 882, and a communication device 883. Furthermore, the hardware configuration illustrated here is an example and some component may also be omitted. Furthermore, a component other than the components illustrated here may also be further included.

(Processor 871)

The processor 871 functions as, for example, an arithmetic processing device or a control device, and controls overall or part of the operation of each of the components based on various kinds of programs recorded in the ROM 872, the RAM 873, the storage 880, or a removable recording medium 901.

(ROM 872 and RAM 873)

The ROM 872 is a means for storing programs read by the processor 871, data used for calculations, and the like. The RAM 873 temporarily or permanently stores therein, for example, programs read by the processor 871, various parameters that are appropriately changed during execution of the programs, and the like.

(Host Bus 874, Bridge 875, External Bus 876, and Interface 877)

The processor 871, the ROM 872, and the RAM 873 are connected to one another via, for example, the host bus 874 capable of performing high-speed data transmission. In contrast, the host bus 874 is connected to the external bus 876 whose data transmission speed is relatively low via, for example, the bridge 875. Furthermore, the external bus 876 is connected to various components via the interface 877.

(Input Device 878)

As the input device 878, for example, a mouse, a keyboard, a touch panel, a button, a switch, a lever, or the like is used. Furthermore, as the input device 878, a remote controller (hereinafter, referred to as a controller) capable of transmitting control signals using infrared light or other radio waves may sometimes be used. Furthermore, the input device 878 includes a voice input device, such as a microphone.

(Output Device 879)

The output device 879 is, for example, a display device, such as a Cathode Ray Tube (CRT), an LCD, and an organic EL; an audio output device, such as a loudspeaker and a headphone; or a device, such as a printer, a mobile phone, or a facsimile, that is capable of visual or aurally notifying a user of acquired information. Furthermore, the output device 879 according to the present disclosure includes various vibration devices capable of outputting tactile stimulation.

(Storage 880)

The storage 880 is a device for storing various kinds of data. As the storage 880, for example, a magnetic storage device, such as a hard disk drive (HDD), a semiconductor storage device, an optical storage device, a magneto optical storage device, or the like may be used.

(Drive 881)

The drive 881 is a device that reads information recorded in the removable recording medium 901, such as a magnetic disk, an optical disk, a magneto-optic disk, or a semiconductor memory, or that writes information to the removable recording medium 901.

(Removable Recording Medium 901)

The removable recording medium 901 is, for example, various kinds of semiconductor storage media, such as a DVD medium, a Blu-ray (registered trademark) medium, or an HD DVD medium. Of course, the removable recording medium 901 may also be, for example, an IC card on which a contactless IC chip is mounted, an electronic device, or the like.

(Connection Port 882)

The connection port 882 is a port, such as a universal serial bus (USB) port, an IEEE 1394 port, a small computer system interface (SCSI), an RS-232C port, or an optical audio terminal, for connecting an external connection device 902.

(External Connection Device 902)

The external connection device 902 is, for example, a printer, a mobile music player, a digital camera, a digital video camera, an IC recorder, or the like.

(Communication Device 883)

The communication device 883 is a communication device for connecting to a network, and is, for example, a communication card for a wired or wireless LAN, Bluetooth (registered trademark), or wireless USB (WUSB); a router for optical communication or a router for asymmetric digital subscriber line (ADSL); a modem for various kinds of communication, or the like.

### 3. Conclusion

As described above, as one of the features, the information processing apparatus 20 according to an embodiment of the present disclosure includes the control unit 240 that controls registration of an item targeted for a location search, and the control unit 240 issues an image capturing command to an input device and dynamically generates registration information that includes at least image information on an item captured by the input device and label information related to the item. Furthermore, the control unit 240 in the information processing apparatus 20 according to an embodiment of the present disclosure further controls a location search for the item based on the registration information described above. At this time, as one of the features, the control unit 240 searches for the label information on the item that is included in the registration information by using a search key extracted from a semantic analysis result of collected speeches of the user and, if the target item is present, the control unit 240 causes the response information related to the location of the item to be output based on the registration information. According to this configuration, it is possible to implement a location search for an item in which a burden imposed on a user is further reduced.

In the above, although the preferred embodiments of the present disclosure has been described in detail above with reference to the accompanying drawings, the technical scope of the present disclosure is not limited to the examples. It is obvious that those having ordinary knowledge in the technical field of the present disclosure can derive modified examples or revised examples within the scope of the technical ideas described in the claims and it is understood that they, of course, belong to the technical scope of the present disclosure.

For example, in the embodiment described above, a case of searching for an item in user's home, an office, or the like is used as the main example; however, the present techniques are not limited to this. The present techniques may also be used in, for example, accommodation facilities or event facilities used by an unspecified large number of users.

Furthermore, the effects described herein are only explanatory or exemplary and thus are not definitive. In other words, the technique according to the present disclosure can achieve, together with the effects described above or instead of the effects described above, other effects obvious to those skilled in the art from the description herein.

Furthermore, it is also possible to create programs for allowing the hardware of a computer including a CPU, a ROM, and a RAM to implement functions equivalent to those held by the information processing apparatus 20 and it is also possible to provide a non-transitory computer readable recording medium in which the programs are recorded.

Furthermore, each of the steps related to the processes performed by the wearable terminal 10 and the information processing apparatus 20 in this specification does not always need to be processed in time series in accordance with the order described in the flowchart. For example, each of the steps related to the processes performed by the wearable terminal 10 and the information processing apparatus 20 may also be processed in a different order from that described in the flowchart or may also be processed in parallel.

Furthermore, the following configurations are also within the technical scope of the present disclosure.

(1)

An information processing apparatus comprising:

a control unit that controls registration of an item targeted for a location search, wherein

the control unit issues an image capturing command to an input device and causes registration information that includes at least image information on an image on the item captured by the input device and label information related to the item to be dynamically generated.

(2)

The information processing apparatus according to (1), wherein, when a speech of a user collected by the input device intends to register the item, the control unit issues the image capturing command and causes the label information to be generated based on the speech of the user.

(3)

The information processing apparatus according to (2), wherein the input device is a wearable terminal worn by the user.

(4)

The information processing apparatus according to (2) or (3), wherein

the registration information includes owner information that indicates an owner of the item, and

the control unit causes the owner information to be generated based on the speech of the user.

(5)

The information processing apparatus according to any one of (2) to (4), wherein

the registration information includes access information that indicates history of access to the item performed by the user, and

the control unit causes the access information to be generated or updated based on the image information on the image captured by the input device.

(6)

The information processing apparatus according to any one of (2) to (5), wherein

the registration information includes space information that indicates a position of the item in a predetermined space, and

the control unit causes the space information to be generated or updated based on the position of the input device at the time of capturing the image of the item or based on the speech of the user.

(7)

The information processing apparatus according to any one of (2) to (6), wherein

the registration information includes related item information that indicates a positional relationship with another item, and

the control unit causes the related item information to be generated or updated based on the image information on the image of the item or the speech of the user.

(8)

The information processing apparatus according to any one of (2) to (7), wherein

the registration information includes search permission information that indicates the user who is permitted to conduct a location search for the item, and

the control unit causes the search permission information to be generated or updated based on the speech of the user.

(9)

The information processing apparatus according to any one of (2) to (8), wherein, when the registered item is recognized from the image information on the image captured by the input device at predetermined intervals or when it is recognized that the registered item is included in the image information based on the speech of the user, the control unit causes the image information to be added to the registration information on the item.

(10)

An information processing apparatus comprising:

a control unit that controls a location search for an item based on registration information, wherein

the control unit searches for label information on the item that is included in the registration information by using a search key extracted from a semantic analysis result of collected speeches of a user and, when a relevant item is present, the control unit causes response information related to the location of the item to be output based on the registration information.

(11)

The information processing apparatus according to (10), wherein

the registration information includes image information obtained by capturing the location of the item, and

the control unit causes the response information that includes at least the image information to be output.

(12)

The information processing apparatus according to (10) or (11), wherein

the registration information includes space information that indicates a position of the item in a predetermined space, and

the control unit causes, based on the space information, the response information that includes voice information or visual information that indicates the location of the item to be output.

(13)

The information processing apparatus according to any one of (10) to (12), wherein

the registration information includes access information that includes history of an access to the item performed by the user, and

the control unit causes, based on the access information, the response information that includes voice information that indicates a last user who accessed the item to be output.

(14)

The information processing apparatus according to any one of (10) to (13), wherein

the registration information includes related item information that indicates a positional relationship with another item, and

the control unit causes, based on the related item information, the response information that includes voice information that indicates the positional relationship with the other item to be output.

(15)

The information processing apparatus according to any one of (10) to (14), wherein the control unit controls an output of voice information that induces a speech that is given by the user and that is able to be used to extract the search key that limits the registration information obtained as a search result to a single piece of registration information.

(16)

The information processing apparatus according to (15), wherein, when the number of pieces of the registration information obtained as the search result is greater than or equal to two, the control unit causes the voice information that induces the speech that is given by the user and that is able to be used to extract the search key that limits the registration information to the single piece of registration information to be output.

(17)

The information processing apparatus according to (15) or (16), wherein, when the registration information obtained as the search result is zero, the control unit causes the voice information that induces the speech that is given by the user and that is able to be used to extract a search key that is different from the search key that is used for the last search to be output.

(18)

The information processing apparatus according to any one of (10) to (17), wherein the control unit controls, in real time, based on a result of object recognition with respect to image information that is sent from a wearable terminal worn by the user at predetermined intervals, an output of response information that indicates the location of the item searched by the user.

(19)

An information processing method that causes a processor to execute a process comprising:

controlling registration of an item targeted for a location search, wherein

the controlling includes
issuing an image capturing command to an input device, and
generating, dynamically, registration information that includes at least image information on the item captured by the input device and label information related to the item.
   (20)

An information processing method that causes a processor to execute a process comprising:

controlling a location search for an item based on registration information, wherein

the controlling includes
searching label information on the item included in the registration information by using a search key that is extracted from a semantic analysis result of collected speech of a user, and
outputting, when an relevant item is present, response information related to a location of the item based on the registration information.

### REFERENCE SIGNS LIST

10 wearable terminal
20 information processing apparatus
210 image input unit
215 image processing unit
220 voice input unit
225 voice section detecting unit
230 voice processing unit
240 control unit
245 registration information management unit
250 registration information storage unit
255 response information generating unit
260 display unit
265 voice output unit

1. An information processing apparatus comprising:
a control unit that controls registration of an item targeted for a location search, wherein
the control unit issues an image capturing command to an input device and causes registration information that includes at least image information on an image on the item captured by the input device and label information related to the item to be dynamically generated.

2. The information processing apparatus according to claim 1, wherein, when a speech of a user collected by the input device intends to register the item, the control unit issues the image capturing command and causes the label information to be generated based on the speech of the user.

3. The information processing apparatus according to claim 2, wherein the input device is a wearable terminal worn by the user.

4. The information processing apparatus according to claim 2, wherein
the registration information includes owner information that indicates an owner of the item, and
the control unit causes the owner information to be generated based on the speech of the user.

5. The information processing apparatus according to claim 2, wherein
the registration information includes access information that indicates history of access to the item performed by the user, and
the control unit causes the access information to be generated or updated based on the image information on the image captured by the input device.

6. The information processing apparatus according to claim 2, wherein
the registration information includes space information that indicates a position of the item in a predetermined space, and
the control unit causes the space information to be generated or updated based on the position of the input device at the time of capturing the image of the item or based on the speech of the user.

7. The information processing apparatus according to claim 2, wherein
the registration information includes related item information that indicates a positional relationship with another item, and
the control unit causes the related item information to be generated or updated based on the image information on the image of the item or the speech of the user.

8. The information processing apparatus according to claim 2, wherein
the registration information includes search permission information that indicates the user who is permitted to conduct a location search for the item, and
the control unit causes the search permission information to be generated or updated based on the speech of the user.

9. The information processing apparatus according to claim 2, wherein, when the registered item is recognized from the image information on the image captured by the input device at predetermined intervals or when it is recognized that the registered item is included in the image information based on the speech of the user, the control unit causes the image information to be added to the registration information on the item.

10. An information processing apparatus comprising:
a control unit that controls a location search for an item based on registration information, wherein
the control unit searches for label information on the item that is included in the registration information by using a search key extracted from a semantic analysis result of collected speeches of a user and, when a relevant item is present, the control unit causes response information related to the location of the item to be output based on the registration information.

11. The information processing apparatus according to claim 10, wherein
the registration information includes image information obtained by capturing the location of the item, and
the control unit causes the response information that includes at least the image information to be output.

12. The information processing apparatus according to claim 10, wherein
the registration information includes space information that indicates a position of the item in a predetermined space, and
the control unit causes, based on the space information, the response information that includes voice information or visual information that indicates the location of the item to be output.

13. The information processing apparatus according to claim 10, wherein
the registration information includes access information that includes history of an access to the item performed by the user, and
the control unit causes, based on the access information, the response information that includes voice information that indicates a last user who accessed the item to be output.

14. The information processing apparatus according to claim 10, wherein
the registration information includes related item information that indicates a positional relationship with another item, and
the control unit causes, based on the related item information, the response information that includes voice information that indicates the positional relationship with the other item to be output.

15. The information processing apparatus according to claim 10, wherein the control unit controls an output of voice information that induces a speech that is given by the user and that is able to be used to extract the search key that limits the registration information obtained as a search result to a single piece of registration information.

16. The information processing apparatus according to claim 15, wherein, when the number of pieces of the registration information obtained as the search result is greater than or equal to two, the control unit causes the voice information that induces the speech that is given by the user and that is able to be used to extract the search key that limits the registration information to the single piece of registration information to be output.

17. The information processing apparatus according to claim 15, wherein, when the registration information obtained as the search result is zero, the control unit causes the voice information that induces the speech that is given by the user and that is able to be used to extract a search key that is different from the search key that is used for the last search to be output.

18. The information processing apparatus according to claim 10, wherein the control unit controls, in real time, based on a result of object recognition with respect to image information that is sent from a wearable terminal worn by the user at predetermined intervals, an output of response information that indicates the location of the item searched by the user.

19. An information processing method that causes a processor to execute a process comprising:
controlling registration of an item targeted for a location search, wherein
the controlling includes
issuing an image capturing command to an input device, and
generating, dynamically, registration information that includes at least image information on the item captured by the input device and label information related to the item.

20. An information processing method that causes a processor to execute a process comprising:
controlling a location search for an item based on registration information, wherein
the controlling includes
searching label information on the item included in the registration information by using a search key that is extracted from a semantic analysis result of collected speech of a user, and
outputting, when an relevant item is present, response information related to a location of the item based on the registration information.
